(19) United States
(12) Patent Application Publication
(10) Pub. No.: US 2015/0262736 A1
(43) Pub. Date: Sep. 17, 2015

(54) GRAPHENE CONDUCTING WIRE PRODUCTION METHOD

(71) Applicant: Merry Electronics (Suzhou) Co., Ltd., Suzhou City (CN)

(72) Inventors: Tse-Yu LIU, Taichung City (TW); Zhi-Yuan LI, Taichung City (TW); Yuan YUAN, Taichung City (TW)

(73) Assignee: MERRY ELECTRONICS (SUZHOU) CO., LTD., Suzhou City (CN)

(21) Appl. No.: 14/206,456

(22) Filed: Mar. 12, 2014

(51) Int. Cl. H01B 13/00; C23C 18/12; H01B 13/06

(52) U.S. Cl. CPC H01B 13/0016; H01B 13/06; C23C 18/1241; C23C 18/1275

(57) ABSTRACT

The present invention discloses a graphene conducting wire production method which involves preparing a grapheme oxide in the form of a solution, applying the solution to the surface of a metallic wire uniformly, heating the graphene oxide at a high temperature to turn it into a graphene by reduction reaction, and attaching the graphene to the surface of the metallic wire. The production method of the present invention eliminates technical difficulties in producing conventional graphene conducting wires.

### BACKGROUND OF THE INVENTION

1. Technical Field

The present invention relates to a graphene conducting wire production method.

2. Description of Related Art

There is a wide variety of conventional enamelled wires, such as pure copper wires, alloy wires, and copper-clad aluminum wires, but they have plenty drawbacks, including overly high resistivity, heavy, brittle, and likely to sever. In an attempt to overcome the aforesaid drawbacks, researchers find that a solution lies in graphene—a new material which not only features high strength and high electrical conductivity but is also heat dissipation-efficient and lightweight. However, it is difficult for graphene to be coupled to thin conducting wires. Accordingly, it is imperative to provide a method of producing a thin conducting wire covered with graphene.

### SUMMARY OF THE INVENTION

It is an objective of the present invention to provide a graphene conducting wire production method.

In order to achieve the above and other objectives, the present invention provides a graphene conducting wire production method comprising the steps of:
1) stretching a metal such that the metal forms a conducting wire;
2) preparing a graphene oxide solution from a graphene oxide and a solvent;
3) applying the graphene oxide solution to a surface of the conducting wire uniformly;
4) heating, in an inert gas protection environment and at 100° C.-700° C., the conducting wire covered with the graphene oxide solution in step 3) to turn the graphene oxide into a graphene by reduction reaction;
5) applying an insulating paint to the graphene-clad conducting wire and then baking the conducting wire, repeatedly, until an insulating paint film is formed on the surface of the conducting wire; and
6) cooling the conducting wire and storing it.

Preferably, the metal in step 1) is one of copper, silver, and aluminum.

Preferably, the solvent in step 2) is water, organic solvent, or a mixture thereof.

Preferably, the inert gas in step 3) is nitrogen gas.

Due to its aforesaid technical solution, the present invention has advantages over the prior art as follows: according to the present invention, a graphene oxide solution adheres to the surface of a metallic conducting wire, and then the graphene oxide solution undergoes reduction reaction to produce a graphene-clad conducting wire, thereby eliminating technical difficulties in producing conventional graphene conducting wires.

### DETAILED DESCRIPTION OF THE EMBODIMENT OF THE INVENTION

The present invention is hereunder illustrated with an embodiment in conjunction with the accompanying drawings.

In an embodiment of the present invention, a graphene conducting wire production method comprises the steps of:
1) stretching copper such that the copper forms a pure-copper conducting wire;
2) dissolving a graphene oxide in water to prepare a graphene oxide solution;
3) applying the graphene oxide solution to a surface of the conducting wire uniformly;
4) heating, in a nitrogen gas protection environment and at 100° C.-700° C., the conducting wire covered with the graphene oxide solution in step 3) to turn the graphene oxide into a graphene by reduction reaction;
5) applying an insulating paint to the graphene-clad conducting wire and then baking the conducting wire; and
6) cooling the conducting wire and storing it.

In this embodiment, the graphene conducting wire production method entails applying a graphene oxide solution to the surface of a metallic conducting wire uniformly and then heating the metallic conducting wire covered with the graphene oxide solution at a high temperature and by reduction reaction to produce the graphene-clad conducting wire, thereby eliminating technical difficulties in producing conventional graphene conducting wires.

The aforesaid embodiment is illustrative of the technical concepts and features of the present invention and is intended to enable persons skilled in the art to understand the contents of the present invention and implement the present invention accordingly, but is not restrictive of the claims of the present invention. All equivalent variations or modifications made substantially to the aforesaid embodiment in accordance with the spirit of the present invention must be interpreted to fall within the claims of the present invention.

What is claimed is:

1. A graphene conducting wire production method, comprising the steps of:
1) stretching a metal such that the metal forms a conducting wire;
2) preparing a graphene oxide solution from a graphene oxide and a solvent;
3) applying the graphene oxide solution to a surface of the conducting wire uniformly;
4) heating, in an inert gas protection environment and at 100° C.-700° C., the conducting wire covered with the graphene oxide solution in step 3) to turn the graphene oxide into a graphene by reduction reaction;
5) applying an insulating paint to the graphene-clad conducting wire and then baking the conducting wire; and
6) cooling the conducting wire and storing it.

2. The graphene conducting wire production method of claim 1, characterized in that the metal in step 1) is one of copper, silver, and aluminum.

3. The graphene conducting wire production method of claim 1, characterized in that the solvent in step 2) is water, organic solvent, or a mixture thereof

4. The graphene conducting wire production method of claim 1, characterized in that the inert gas in step 3) is nitrogen gas.
